(19) United States
(12) Patent Application Publication
(10) Pub. No.: US 2026/0201109 A1
(43) Pub. Date: Jul. 16, 2026

(54) RECYCLABLE SANDWICH STRUCTURE COMPOSITES

(71) Applicant: CTP ADVANCED MATERIALS GMBH., RÜSSELSHEIM (DE)

(72) Inventors: Andreas PALINSKY, MOERS (DE); TANJA PANICK, DUISBURG (DE)

(21) Appl. No.: 19/136,650

(22) PCT Filed: Dec. 8, 2023
(86) PCT No.: PCT/IB2023/062402

§ 371 Date: Jun. 6, 2025

(30) Foreign Application Priority Data
Dec. 8, 2022 (IN) 202211063637

(51) Int. Cl. C08G 59/40; B32B 5/02; B32B 5/18; B32B 5/24; B32B 27/38; C08G 59/50; C08J 5/24; C08J 9/00; C08J 9/32; C08J 11/08; C08L 63/00

(52) U.S. Cl. CPC C08G 59/4007; B32B 5/02; B32B 5/18; B32B 5/245; B32B 27/38; C08G 59/5006; C08G 59/504; C08J 5/244; C08J 9/0061; C08J 9/32; C08J 11/08; C08L 63/00; B32B 2250/40; B32B 2307/716; B32B 2307/72; B32B 2307/7376; B32B 2607/00; C08J 2363/00; C08J 2467/00; C08J 2483/05; C08L 2203/14

(57) ABSTRACT

A composite structure is disclosed. Said composite structure comprises two skin sheets, and a core member arranged between the two skin sheets. The skin sheet comprises a reinforcing fibre impregnated with a recyclable epoxy resin. The core member comprises the recyclable epoxy resin, a reinforcing component, and a foaming agent. Said recyclable epoxy resin comprises at least one epoxy resin component and a recyclable curing agent wherein the recyclable curing agent is selected from a group consisting of a compound of Formula (I) and a compound of Formula (II).

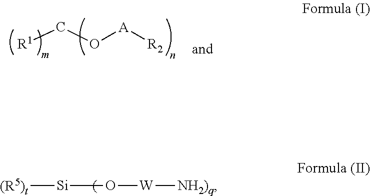

### FIELD OF THE INVENTION

The present disclosure relates to a composite structure. In particular, the present disclosure relates to a recyclable composite structure comprising an epoxy resin component and a recyclable curing agent.

### BACKGROUND

Sandwich structure is a special class of composite material that comprises of two skin sheets and a core member that is interposed between the two skin sheets. Sandwich structures may be flat panels or curved and find application in automobiles, aircraft, wind turbines, building material and sports equipment etc.

Sandwich structures are usually manufactures with reinforced thermoplastic material, specifically fibre reinforced thermoplastic material. However, lately thermosetting polymer materials such as polyester, vinyl ester or epoxy resin are also used in manufacturing of sandwich structures as an alternative to thermoplastic material.

Thermosetting composite materials however have, several disadvantages. A major disadvantage of thermosetting composite is that unlike thermoplastics, thermosetting polymer materials are not recyclable. As a result, the thermoset waste generated during manufacturing and end-of-life poses a significant environmental challenge across the globe.

Among the thermosetting polymers epoxy resins offer a unique combination of thermal, mechanical and chemical resistance properties that are unattainable with other thermoset resins.

However, since the epoxy resin becomes infusible and insoluble in general-purpose solvents after it is thermo-cured, it is difficult to recycle the epoxy resin-cured products and products to which the epoxy resin-cured product adheres or on which the epoxy resin-cured product is applied. Particularly, epoxy resins are not melted by heat once they are hardened and reuse thereof as a resin material is difficult. Hence, at the end-of-life, it becomes a challenging problem to recover and reuse the valuable components such as carbon fiber, glass fiber and plastic material in a polymer matrix.

### BRIEF DESCRIPTION OF DRAWINGS

FIG. 1 depicts the weight loss of the specimen of the cubic foam sandwich panel during recycling in an acetic acid solution in accordance with an embodiment of the present disclosure.

FIG. 2 depicts the recycling process of the specimen of the cubic foam sandwich panel in accordance with an embodiment of the present disclosure.

FIG. 3 depicts the recovery process of the recyclable epoxy resin in the form of a thermoplastic particles in accordance with an embodiment of the present disclosure.

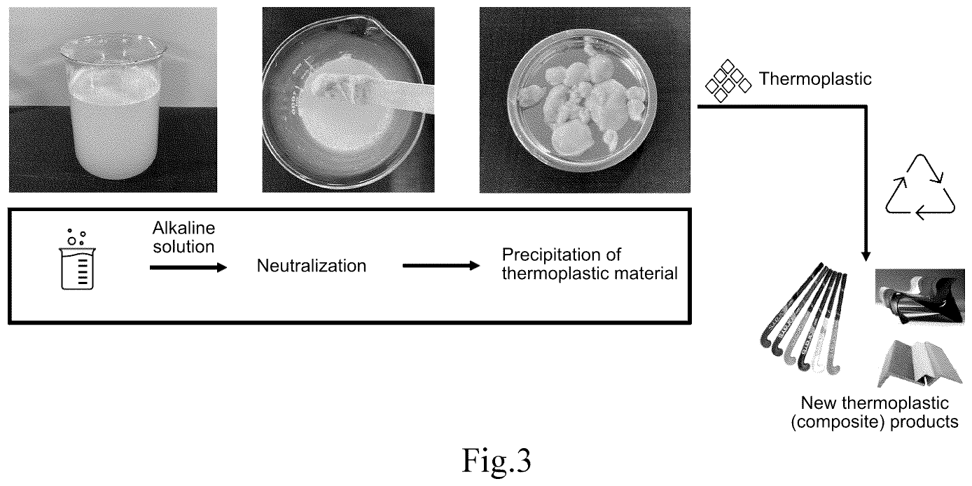

### SUMMARY

A composite structure is disclosed. Said composite structure comprises two skin sheets, and a core member arranged between the two skin sheets. The skin sheet comprises a reinforcing fibre impregnated with a recyclable epoxy resin. The core member comprises the recyclable epoxy resin, a reinforcing component, and a foaming agent. Said recyclable epoxy resin comprises at least one epoxy resin component and a recyclable curing agent wherein the recyclable curing agent is selected from a group consisting of a compound of Formula (I):

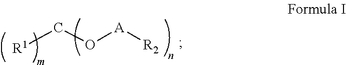

and
wherein:
if m is 2, then n is 2;
if m is 1, then n is 3; or
if m is 0, then n is 4;
each R¹ is independently hydrogen, alkyl, cycloalkyl, heterocycle, heterocycloalkyl, alkenyl, cycloalkenyl, aryl, heteroaryl, alkoxyalkyl, or alkynyl;
each A is independently alkyl, alkylene, alkenene, alkylene-hetero-alkylene, alkylene-heterocyclo-alkylene, carbonyl, thiocarbonyl, alkylene-oxy-alkylene, 1,4-alkyl substituted piperazine, aryl, or heteroaryl;
each R² is independently —NHR3, —SH, or heterocycloalkyl, wherein each R³ is independently hydrogen, alkyl, aminoalkyl, alkylaminoalkyl, cycloalkyl, heterocycle, alkenyl, aryl, or heteroaryl; or, every two —O-A-R2 groups, together with the carbon atom to which they are attached to, can independently form an dioxanyl ring with no less than 4 ring members and one or more of the ring carbon atom(s), other than the carbon atom to which the two —O-A-R2 groups are attached, are independently substituted with one or more independent amino group or aminoalkyl wherein each amino is independently a primary or secondary amino group; and
a compound of Formula (II):

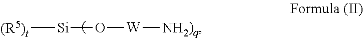

wherein:
q is 4, 3, 2, or 1;
t is 0, 1, 2, or 3;
the sum of q and t is 4;
each occurrence of W is independently alkylene, cycloalkylene, heterocyclylene, alkenylene, alkynylene, cycloalkenylene, arylene, or heteroarylene; and
each occurrence of R⁵ is independently hydrogen, alkyl, aminoalkyl, cycloalkyl, heterocyclyl, alkenyl, alkynyl, cycloalkenyl, aryl, heteroaryl or —OR^{c}, wherein R_{c} is alkyl, cycloalkyl, heterocyclyl, alkenyl, alkynyl, cycloalkenyl, aryl or heteroaryl.

An epoxy resin for preparing a recyclable epoxy foam is also disclosed. The epoxy resin comprises at least one epoxy resin component, a recyclable curing agent, a reinforcing component, and a foaming agent wherein the recyclable curing agent is selected from a group consisting of a compound of Formula (I) and Formula (II).

The compound of Formula (I) is a compound of Formula (III) represented by:

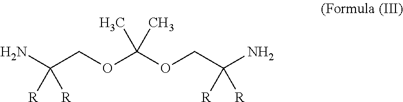

wherein each R is independently hydrogen, methyl or ethyl; and
The compound of Formula (II) is a compound of Formula (IV) represented by:

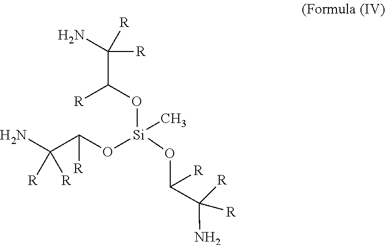

wherein each R is independently hydrogen, methyl or ethyl.

### DETAILED DESCRIPTION

To promote an understanding of the principles of the disclosure, reference will now be made to embodiments and specific language will be used to describe the same. It will nevertheless be understood that no limitation of the scope of the disclosure is thereby intended, such alterations and further modifications in the disclosed composition and process, and such further applications of the principles of the disclosure therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “one embodiment” “an embodiment” or similar language means that a particular feature, structure, or characteristic described in connection with the embodiment is included in at least one embodiment of the present disclosure. Thus, appearances of the phrase “in one embodiment”, “in an embodiment” and similar language throughout this specification may, but do not necessarily, all refer to the same embodiment.

In the broadest scope, the present disclosure relates to a composite structure. Specifically, the composite structure comprising two skin sheets, and a core member arranged between the two skin sheets. The skin sheet comprises a reinforcing fibre impregnated with a recyclable epoxy resin; and the core member comprises the recyclable epoxy resin, a reinforcing component, and a foaming agent. The recyclable epoxy resin comprising at least one epoxy resin component and a recyclable curing agent wherein the recyclable curing agent is selected from a group consisting of a compound of Formula (I) and a compound of Formula (II).

The compound of Formula (I) is represented by:

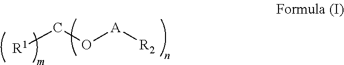

wherein
if m is 2, then n is 2;
if m is 1, then n is 3;
if m is 0, then n is 4;
the sum of m and n is 4;
each R₁ is independently hydrogen, alkyl, cycloalkyl, heterocycle, heterocycloalkyl, alkenyl, cycloalkenyl, aryl, heteroaryl, alkoxyalkyl, or alkynyl;
each A is independently alkyl, alkylene, alkenene, alkylene-hetero-alkylene, alkylene-heterocyclo-alkylene, carbonyl, thiocarbonyl, alkylene-oxy-alkylene, 1,4-alkyl substituted piperazine, aryl, or heteroaryl;
each R² is independently —NHR³, —SH, or heterocycloalkyl, wherein each R³ is independently hydrogen, alkyl, aminoalkyl, alkylaminoalkyl, cycloalkyl, heterocycle, alkenyl, aryl, or heteroaryl; or, every two —O-A-R2 groups, together with the carbon atom to which they are attached to, can independently form an dioxanyl ring with no less than 4 ring members and one or more of the ring carbon atom(s), other than the carbon atom to which the two —O-A-R2 groups are attached, are independently substituted with one or more independent amino group or aminoalkyl wherein each amino is independently a primary or secondary amino group.

In some embodiments, in the compound of Formula (I) m is 2, n is 2; each R¹ is hydrogen or alkyl; A is independently alkyl or aryl; each R² is independently —NHR3, or —SH; and each R³ is independently hydrogen or alkyl.

In some embodiments, the compound of Formula (I) is a compound of formula (III) represented by:

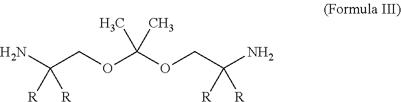

wherein R is independently hydrogen, methyl or ethyl.

In an embodiment, the compound of Formula (I) is:

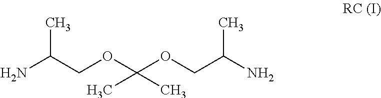

The compound of Formula (II) is represented by:

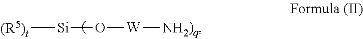

wherein:
q is 4, 3, 2, or 1;
t is 0, 1, 2, or 3;
the sum of q and t is 4;
each W is independently alkylene, cycloalkylene, heterocyclylene, alkenylene, alkynylene, cycloalkenylene, arylene, or heteroarylene; and
each R⁵ is independently hydrogen, alkyl, cycloalkyl, heterocyclyl, alkenyl, alkynyl, cycloalkenyl, aryl, heteroaryl or —OR^{c}, wherein R^{c} is alkyl cycloalkyl, heterocyclyl, alkenyl, alkynyl, cycloalkenyl, aryl, or heteroaryl.

In some embodiments, in the compound of Formula (II) q is 3 or 4; t is 1 or 0; W is independently alkylene, cycloalkylene, or arylene; and R⁵ is independently hydrogen, alkyl, or aminoalkyl.

In some embodiments, the compound of Formula (II) is a compound of Formula (IV) represented by:

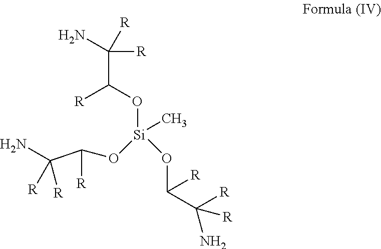

wherein each R is independently hydrogen, methyl or ethyl.

In some embodiments, the compound of Formula (II) is:

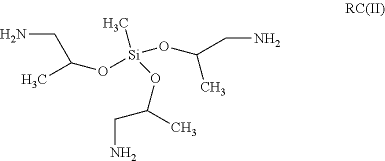 [SMILES: CC(CN)O[Si](C)(OC(C)CN)OC(C)CN]

In an embodiment, the compound of Formula (I) and the compound of Formula (II) is used as the recyclable curing agent for curing thermosetting polymers such as epoxies. The compound of Formula (I) and the compound of Formula (II) enable the degradation of the cured thermosetting polymers due to the presence of cleavable linkage. The cleavage linkage is acid labile and undergo a bond cleavage reaction at an elevated temperature or in an acidic solution resulting in dissolution of the thermosetting polymers. The cleavage linkage includes either an acetal linkage a ketal linkage, an orthoester linkage, or an orthocarbonate linkage. In an embodiment, the disclosed composite structure is recyclable.

### Skin Layer

The skin layer comprises of a reinforcing fibre impregnated with a recyclable epoxy resin.

Each of the skin layer has a thickness in the range of 0.2 to 10 millimetres. In some embodiments, each of the skin layer has the thickness of 1 millimetre. In some embodiments each of the skin layer has the same thickness. In some embodiments, each of the skin layer may have a different thickness.

In an embodiment, the reinforcing fibre is selected from the group consisting of glass fibre, carbon fibre, ceramic fibre, natural fibre and a combination thereof. In some embodiments, the reinforcing fibre is glass fibre. In an embodiment, the reinforcing fibre is present in the skin sheet in an amount in a range of 50-60 wt. % based on the total weight of the skin sheet.

### Core Member

The core member comprises the recyclable epoxy resin, a reinforcing component and a foaming agent. The core member has a thickness in the range of 2 to 200 millimetre. In some embodiments, the core member has the thickness of 10 millimetre.

In an embodiment, the reinforcing component is selected from a group consisting of hollow glass spheres, chopped glass fibres, chopped carbon fibres, natural fibres, expanded glass, polymer sphere and a combination thereof. In some embodiments, the reinforcing component is hollow glass spheres. In an embodiment, the reinforcing component is added in an amount in a range of 10-20 wt. % based on the total weight of the core member.

In an embodiment, the foaming agent is selected from the group consisting of an anhydrous silicone and functional carbonic acid diamides. In an embodiment, the foaming agent is polymethylhydrogensiloxane. In an embodiment, the foaming agent is added in an amount in a range of 1-3 wt. % of the total weight of the core member.

In an embodiment, the core member further comprises a flexibilization agent, a filler, a dispersing agent, and optionally a reactive diluent and a toughener.

In an embodiment, the flexibilization agent is selected from the group consisting of linear polymers with ether and/or urethane groups containing crosslinkable, blocked isocyanate groups, phenolic lipids from anacardic acid, and polyurethanes. In some embodiments, the flexibilization agent is a linear polymer with ether and urethane groups. In an embodiment, the flexibilization agent is added in an amount in the range of 15-20 wt. % of the total weight of the recyclable epoxy resin.

In an embodiment, the dispersing agent is high molecular polyesters. In an embodiment, the dispersing agent is added in an amount in the range of 1-3 wt. % of the total weight of the recyclable epoxy resin.

In an embodiment, the surfactant is selected from the group consisting of sorbitan monooleates, polyethylene sorbitol esters or mixtures thereof, cardanol ethoxylates, and poloxamers. In some embodiments, the surfactant is a mixture of sorbitan monooleates and polyethylene sorbitol ester. In an embodiment, the surfactant is added in an amount in the range of 1-2 wt. % of the total weight of the recyclable epoxy resin.

In an embodiment, the reactive diluent is selected from the group consisting of a reaction products of hexane-1,6-diol with 2-(chloromethyl) oxirane, glycidylether C₁₂-C₁₄ alcohol, 1,2,3-Propanetriol, homopolymer, 2-oxiranylmethyl ether, and 1,4-Bis(2,3-epoxypropoxy) butane. In an embodiment, the reactive diluent is added in an amount in the range of 5-10 wt. % of the total weight of the recyclable epoxy resin.

In an embodiment, the solid toughener is methyl methacrylate-butadiene-styrene. In an embodiment, the solid toughener is added in an amount in the range of 10-20 wt. % of the total weight of the recyclable epoxy resin.

### Recyclable Epoxy Resin

The recyclable epoxy resin comprises of the epoxy resin component and the recyclable curing agent.

In an embodiment, the epoxy resin component is selected from a group consisting of diglycidyl ether of bisphenol A, diglycidyl ether of bisphenol F, a mixture of diglycidyl ether of bisphenol A and bisphenol F, a cycloaliphatic epoxy resin and a combination thereof.

In an embodiment, the epoxy resin component and the recyclable curing agent are added in the stoichiometric ratio in the range between 100:20 to 100:30. In some embodiments, the epoxy resin component and the recyclable curing agent are added in the stoichiometric ratio of 100:26.

In accordance with an embodiment, the epoxy resin component and the recyclable curing agent are added based on their Epoxy Equivalent Weight (EEW) and Amine Hydrogen Equivalent Weight (AHEW). The weight of the recyclable curing agent component(s) for 100 g of the epoxy resin component in the epoxy resin system may be calculated using below formula:

$$Weight of recyclable curing agent = AHEW * 100 / Epoxy Equivalent Weight$$

The recyclable curing agent when cured with the epoxy resin component forms a cross-linked thermoset that can be chemically broken down unlike a conventional epoxy thermoset prepared by using a conventional curing agent and the epoxy resin component.

In accordance with an embodiment, the viscosity of the recyclable epoxy resin is in the range of 10,000-40,000 cps. In some embodiments, the viscosity of the recyclable epoxy resin is 35,000 cps.

In accordance with an embodiment, the glass transition temperature of the recyclable epoxy resin is in the range of 70-115° C. In some embodiments, the glass transition temperature of the recyclable epoxy resin is 80° C.

The composite is prepared by at least one method selected from a group consisting of wet-lay-up, infusion, and vacuum assisted resin transfer molding (VARTM).

The composite structure produced in accordance with the present disclosure is cured at a room temperature. For complete cross-linking and attaining optimum mechanical properties, the composite structure can be cured at an elevated temperature. In some embodiments, the composite structure produced in accordance with the present disclosure is cured at an elevated temperature in the range of 20° C.-80° C. For heat curing, the composite structure is subjected to heating at a predetermined temperature for a predetermined period of time.

### Composite Structure

In an embodiment, the composite structure has a thickness in a range between 10 millimetres to 40 millimetres. In some embodiments, the composite structure has thickness of 15 millimetres.

In an embodiment, the compressive strength of the composite structure having a thickness of between 10 millimetres to 40 millimetres is in a range of 5.0 MPa to 1.2 MPa.

In an embodiment, the density of the composite structure having a thickness of between 10 millimetres to 40 millimetres is in a range of 450 kg/m³ to 220 kg/m³.

In an embodiment, the composite structure has a glass transition temperature of between 75° C. to 90° C. when the composite structure is post-cured at 120° C. for 2 hours. In some embodiments, the composite structure has a glass transition temperature of 80° C. when the composite structure is post cured at 120° C. for 2 hours.

In an embodiment, the composite structure is capable of disintegrating when immersed in an acid solution at a temperature in a range of 50° C. to 110° C., to recover the reinforcing fibre, the reinforcing component, the filler and to obtain a thermoplastic material. The disclosed composite structure can be disassembled and cleaved under controlled conditions into smaller, soluble molecules and/or polymer. The composite structure comprises cleavage points that converts thermoset epoxy into the thermoplastic material. These cleavage points are reversible and enable disintegration of the thermoset epoxy. The immersion of the composite structure in the acid solution will induce cleavage of the cross-linked network of the composite structure.

In an embodiment, the composite structure is immersed in the acid solution for a sufficient period for disassembling the composite structure. The period that is required for dissolution of the composite structure ranges from at least 2 hours to 4 hours. In an embodiment, the acid in which the composite structure is immersed is selected from a group comprising of acetic acid, hydrochloric acid, sulphuric acid, phosphoric acid. In some embodiments, the acid is mild acetic acid.

### Epoxy Resin for a Recyclable Epoxy Foam

An epoxy resin for preparing a recyclable epoxy foam is also disclosed. The epoxy resin comprises at least one epoxy resin component, a recyclable curing agent, a reinforcing component, and a foaming agent.

In an embodiment, the epoxy resin component is selected from a group consisting of diglycidyl ether of bisphenol A, diglycidyl ether of bisphenol F, a mixture of diglycidyl ether of bisphenol A and bisphenol F, a cycloaliphatic epoxy resin and a combination thereof.

The recyclable curing agent is selected from a group consisting of a compound of Formula (I) and Formula (II), wherein the compound of Formula (I) is the compound of Formula (III) represented by:

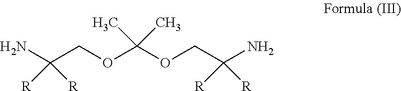

wherein each R is independently hydrogen, methyl or ethyl; and
wherein the compound of Formula (II), is the compound of Formula (IV) represented by:

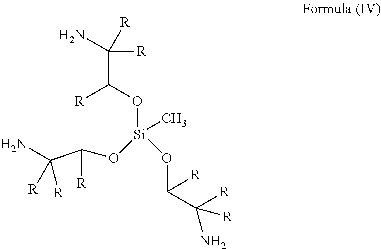

wherein each R is independently hydrogen, methyl or ethyl.

The disclosure also relates to an epoxy resin for preparing an epoxy foam having density in a range of 140-190 kg/m³. In an embodiment, the epoxy resin comprises a reaction product of hexane 1,6-diol with 2-(chloromethyl) oxirane, hyperbranched polyester, polymethylhydrogensiloxane, glass hollow bubbles, and a compound of Formula (I), wherein the compound of formula (I) is:

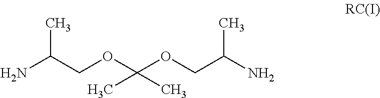

wherein, the epoxy resin is cured at a temperature in a range between 70° C.-90° C. In an embodiment, the reaction product of hexane 1,6-diol with 2-(chloromethyl) oxirane is added in an amount in a range of 5-10 wt. % of the total weight of the epoxy resin. In some embodiments, the reaction product of hexane 1,6-diol with 2-(chloromethyl) oxirane is added in 8 wt. % of the total weight of the epoxy resin.

In an embodiment, hyperbranched polyester is added in a range of 1.5-2.0% phr of the total weight of the epoxy resin.

In an embodiment, polymethylhydrogensiloxane is added in a range of 2.0-3.0% of the total weight of the epoxy resin phr. In some embodiments, polymethylhydrogensiloxane is added in 2 wt. % of the total weight of the epoxy resin.

In an embodiment, glass hollow bubbles are added in a range of 13.0-16.0% phr of the total weight of the epoxy resin. In some embodiments, glass hollow bubbles are added in 15 wt. % of the total weight of the epoxy resin.

In some embodiments, the epoxy foam has the density of not more than 100 kg/m³.

The disclosure also relates to an epoxy resin for preparing an epoxy foam having thickness in a range of 160 mm to 200 mm. In an embodiment, the epoxy resin comprises reactive diluted BPA-resin, fumed silica, polymethylhydrogensiloxane, glass hollow bubbles, and the compound of Formula (I), wherein the compound of Formula (I) is:

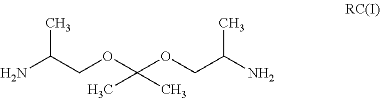

wherein, the epoxy resin is cured at a temperature in a range between 20-30° C.

In an embodiment, the reactive diluted BPA resin has a viscosity in a range of 1000-1500 mPa·s. In some embodiments, the reactive diluted BPA resin has the viscosity of 1200 mPa·s. In an embodiment, the reactive diluted BPA resin is added in an amount in a range of 5-10 wt. % of the total weight of the epoxy resin. In an embodiment, the reactive diluted BPA resin is added in an amount of 8 wt. % of the total weight of the epoxy resin.

In an embodiment, fumed silica is added in a range of 0.5-1.5% phr of the total weight of the epoxy resin. In some embodiments, fumed silica is added in 1% phr.

In an embodiment, polymethylhydrogensiloxane is added in a range of 2.0-3.0% phr of the total weight of the epoxy resin. In some embodiments, polymethylhydrogensiloxane is added in 2% phr of the total weight of the epoxy resin.

In an embodiment, glass hollow bubbles are added in a range of 13.0-16.0% phr of the total epoxy resin.

In some embodiments, the epoxy foam has a thickness of 150 millimetre.

The disclosure further provides a process for preparing a recyclable epoxy resin that may be used for preparing a recyclable composite material or recyclable foam for preparing recyclable composite material. The process comprises of mixing together the epoxy resin component, and optionally reactive diluents to form a mixture. To said mixture wetting agent, dispersing agent, and flexibilization agent, are added, and the mixture so obtained is stirred uniformly. In the next step, to the stirred mixture, blowing agent is added and the mixture is stirred to obtain a liquid homogeneous precursor. To the liquid homogenous precursor, solid tougheners are optionally added and mixed intensively for good distribution, followed by addition of a nucleation agent and fillers to obtain a premixed resin. To the premixed resin, hollow glass spheres are added and mixed homogenously using an electric stirrer. The shear forces of the electric stirrer are kept low to prevent the hollow glass spheres from being destroyed. The recyclable curing agent is then added and stirred thoroughly to obtain the recyclable epoxy resin. Finally, the recyclable epoxy resin was poured into moulds and cured. In an embodiment, curing is carried out in on a heating table at 50° C. In an embodiment, curing is carried out in an oven at a temperature in a range of 80° C.-120° C.

In an alternate embodiment, the recyclable core of the sandwich structure may be prepared as a continuous process. In said process, the recyclable epoxy resin is poured on a heated belt. The foaming layer is spread to reach a desired thickness and the foaming process is initiated by the temperature of the belt, whereas at the same time the curing reaction is slowly initiated and leading to a mechanical stabilisation of the foam structure at the point of maximum expansion. In accordance with an aspect, the production belt has a requisite length to achieve almost complete cure of the foam upon reaching the end of the belt. The resulting can then be cut by a band saw to block material in the desired dimension.

In an alternate embodiment, the recyclable foam sandwich panel may be prepared as a continuous process on a conveyor belt system. For the continuous process, the recyclable epoxy resin is poured on a bottom layer of a dry fabric or a cured laminate in a defined thickness. In the next step, the recyclable epoxy resin is applied on a top layer of the dry fabric or the cured laminate. The top layer of the dry fabric or the cured laminate can be pre-impregnated or primed with the recyclable epoxy resin for improved adhesion. For curing, the belt is passed through segments with ovens for one step or multiple step curing of the material to result in the sandwich foam panel where the epoxy core is covered by external laminate sheets or dry fabrics. The sandwich panel is allowed to cool below the glass transition temperature and cut to desired lengths at the end of the line.

In accordance with an aspect, because of the exothermic potential of the curing reaction, the temperature of the belt is adjusted and is in the range between 50° C. and 120° C., preferably in the range 70° C. and 110° C.

Since the skin sheet and the core member of the sandwich structure is made of the recyclable skin and the recyclable core, the entire sandwich structure is recyclable.

The composite structure as such provides improved mechanical stability, for instance high load bearing capacity and stiffness. In an embodiment, the sandwich structure composite has a lower weight than conventional components used in the art while at the same time being able to offer adequate or even improved mechanical properties, such as lower density and stiffness.

The invention will now be described with respect to the following examples which do not limit the disclosed method in any way and only exemplify the claimed method. It will be apparent to those skilled in the art that various modifications and variations can be made to the method/process of the present disclosure without departing from the scope of the disclosure. Other embodiments will be apparent to those skilled in the art from consideration of the specification and practice of the method/process disclosed herein. It is intended that the specification and examples be considered as exemplary only, with a true scope of the disclosure being indicated by the following claims and their equivalent.

### EXAMPLES

### Example 1: Preparation of the Composite Structure in Accordance with an Exemplary Embodiment

Preparation of the epoxy resin component: The epoxy resin component was prepared by mixing liquid epoxy resin, poly-glycerol based glycidyl ether, Desmocap 14 CNB, Wacker silres BS94, Disperbyk 2152, and 3M H38HS in specific percentage as mentioned in Table 1 at 23° C. The prepared epoxy resin component was mixed thoroughly until completely homogenized with the help of an electric stirrer with a stirring rate of 100-200 rpm.

TABLE 1
The Epoxy resin component

| S. | | Quantity |
|---|---|---|
| No | Component | (in w/w %) |
| 1. | Liquid epoxy resin | 57.5 |
| 2. | Poly-glycerol based | 6.3 |
| | glycidyl ether | |
| 3. | Desmocap 14 CNB | 16 |
| 4. | Wacker silres BS94 | 2.1 |
| 5. | Disperbyk 2152 | 2.1 |
| 6. | 3M H38HS | 16 |

Preparation of the recyclable epoxy resin: To the prepared epoxy resin component, 100 ml of RC (II) was added and mixed thoroughly to obtain the recyclable epoxy resin.

### Manufacturing of Continuous Foam Sandwich Panel:

The recyclable epoxy resin prepared above was applied by wide-slit nozzles, jets or racles on a continuous moving bottom layer of a cured laminate or dry fabric in a defined thickness. In a next step, the top layer was applied from above either directly on the surface of the recyclable epoxy resin or in a specific distance from the bottom layer, taking into account the subsequent foaming height. This could be realized with spacers on both sides of the line. The top layer of the dry fabric or the cured laminate can be pre-impregnated or primed with the recyclable epoxy resin for improved adhesion. For curing, the belt was passed through segments with ovens for one-step or multiple steps curing of the material to result in the sandwich foam panel with a defined foam thickness. The obtained sandwich foam panel was then allowed to cool below the glass transition temperature and cut to desired lengths at the end of the line.

### Manufacturing of Non-Continuous Foam Sandwich Panels:

A glass fabric Saertex X-E-610 g/m² was taken and cut to the desired length. By using a peel-ply on at least one side, a uniformly rough surface was made. The recyclable epoxy resin prepared above was applied on one side of the glass fabric by using a squeegee on the rough side of the bottom laminate and cured. The top laminate was placed rough side down on the surface of the foam and cured. In the next step, the recyclable epoxy resin was applied to the other side of the fabric followed by curing in an oven at 80° C. for 1 hour. The obtained foam sandwich panel was post cured at 110° C. for 80 minutes.

Mechanical properties of the foam sandwich panel: The compressive tests were performed according to standard ISO 844 to evaluate the properties of the prepared sandwich The mechanical properties of the prepared foam sandwich panels are tabulated in table 2 below:

TABLE 2
Mechanical properties of the prepared foam sandwich panel

| S. No. | Properties | Test method | Example 1 | |
|---|---|---|---|---|
| 1. | Density | ISO 845 | 450 | kg/m³ |
| 2. | Compressive | ISO 844 | 4.5 | MPa |
| | strength | | | |

### Example 2: Preparation of the Composite Structure in Accordance with an Exemplary Embodiment

Preparation of the epoxy resin component: The epoxy resin component was prepared by mixing Epotec YD127, Wacker® Silres BS94, Disperbyk 2152, and 3M H38HS in specific percentage as mentioned in Table 4 at 23° C. The prepared epoxy resin component was mixed thoroughly until completely homogenized with the help of an electric stirrer with a stirring rate of 100-200 rpm.

TABLE 3
The Epoxy resin component

| S. | | Quantity |
|---|---|---|
| No | Component | (in w/w %) |
| 1. | Epotec ® YD 127 | 64 |
| 2. | Wacker ® Silres BS94 | 2 |
| 3. | Disperbyk 2152 | 1 |
| 4. | 3M H38HS | 15 |

Preparation of recyclable epoxy resin: To the prepared epoxy resin component, 100 ml of RC (I) was added and mixed thoroughly to prepare the recyclable epoxy resin.

### Manufacturing of the Continuous Foam Sandwich Panel:

The sandwich foam panel was prepared by the similar procedure as specified in example 1 by using the recyclable epoxy prepared as prepared in example 2. The curing in an oven was done at 60° C. for 3 hours.

Mechanical properties of the foam sandwich panel: The compressive strength tests were performed according to standard ISO 844 to evaluate the properties of the prepared foam sandwich panel. The mechanical properties of the prepared foam sandwich panels are tabulated in table 4 below:

TABLE 4
Mechanical properties of the prepared foam sandwich panel

| S. | | Test | | |
|---|---|---|---|---|
| No. | Properties | method | Example 2 | |
| 1. | Density | ISO 845 | 142 | kg/cm³ |
| 2. | Compressive strength | ISO 844 | 2.62 | MPa |
| 3. | Specific compressive | ISO 844 | 18.45 | Nm/g |
| | strength | | | |

### Example 3: Preparation of the Composite Structure in Accordance with an Exemplary Embodiment

Preparation of the epoxy resin component: The epoxy resin component was prepared by mixing Epotec YD127, Desmocap 14 CNB, Wacker® Silres BS94, Disperbyk 2152, and 3M H38HS in the specified percentage as mentioned in Table 5 at 23° C. The prepared epoxy resin component was mixed thoroughly until completely homogenized with the help of an electric stirrer with a stirring rate of 100-200 rpm.

TABLE 5
The Epoxy resin component

| S. | | Quantity |
|---|---|---|
| No | Component | (in w/w %) |
| 1. | Epotec ® YD 127 | 64 |
| 2. | Desmocap 14 CNB | 16 |
| 3. | Wacker ® Silres BS94 | 2 |
| 4. | Disperbyk 2152 | 2 |
| 5. | 3M H38HS | 16 |

Preparation of recyclable curing agent component: RC (II) and Epotec® YD 128G were mixed in specific percentage as mentioned in Table 6 at 50° C. to prepare the recyclable curing agent component. The prepared recyclable curing agent component was mixed thoroughly until completely homogenized with the help of an electric stirrer with a stirring rate of 200 rpm.

TABLE 6
The recyclable curing agent component

| S. | | Quantity |
|---|---|---|
| No | Component | (in w/w %) |
| 1 | RC (II) | 85 |
| 2 | Epotec ® YD 128G | 15 |

Preparation of recyclable epoxy resin: 10 grams of epoxy resin component formulation and 20 grams of the recyclable curing agent component was mixed to prepare the recyclable epoxy resin. The curing of the epoxy resin component and the recyclable curing agent component was done at 23° C. for 12 hours.

### Manufacturing of the Foam Sandwich Panel:

The sandwich foam panel was prepared by the similar procedure as specified in example 1 by using the recyclable epoxy prepared as prepared in example 3. The curing in an oven was done at 60° C. for 3 hours.

Mechanical properties of the foam sandwich panel: The compressive strength tests were performed according to standard ISO 844 to evaluate the properties of the prepared sandwich The mechanical properties of the prepared foam sandwich panels are tabulated in table 7 below:

TABLE 7
Mechanical properties of the prepared foam sandwich panel

| S. No. | Properties | Test method | Example 3 | |
|---|---|---|---|---|
| 1. | Density | ISO 845 | 185 | kg/cm³ |
| 2. | Compressive strength | ISO 844 | 3.79 | MPa |
| 3. | Specific compressive | ISO 844 | 20.49 | Nm/g |
| | strength | | | |
| 4. | Tg after post cure at | DIN EN ISO | 77° | C. |
| | 120° C. for 2 hrs | 11357-2 | | |

The recyclable epoxy resin prepared above is suitable for preparing relatively big foam panel having thicknesses up to 120 mm in one shot without detrimental exothermic effects.

### Example 4: Preparation of the Composite Structure in Accordance with an Exemplary Embodiment

Preparation of the epoxy resin component: The epoxy resin component was prepared by mixing Epotec YD127, Desmocap 14 CNB, Wacker® Silres BS94, Disperbyk 2152, and 3M H38HS in the specific percentage as mentioned in Table 8 at 23° C. The prepared epoxy resin component was mixed thoroughly until completely homogenized with the help of an electric stirrer with a stirring rate of 100-200 rpm.

TABLE 8
The Epoxy resin component

| S. | | Quantity |
|---|---|---|
| No | Component | (in w/w %) |
| 1 | Epotec ® YD 127 | 67 |
| 2 | Desmocap 14 CNB | 17 |
| 2 | Wacker ® Silres BS94 | 1.5 |
| 3 | Disperbyk 2152 | 1.5 |
| 4. | 3M H38HS | 13 |

Preparation of the recyclable curing agent component: RC (I) and RC (II) were mixed in specific percentage as mentioned in Table 9 below at 23° C. to prepare the curing agent formulation. The prepared recyclable curing agent was mixed thoroughly until completely homogenized with the help of an electric stirrer with a stirring rate of 200 rpm.

TABLE 9
The recyclable curing agent component

| S. | | Quantity |
|---|---|---|
| No | Component | (in w/w %) |
| 1. | RC (I) | 50 |
| 2. | RC (II) | 50 |

Preparation of recyclable epoxy resin: 100 grams of epoxy resin component and 21 grams of the recyclable curing agent was mixed to prepare the recyclable epoxy resin. The curing of the epoxy resin component and the recyclable curing agent component was done at 50° C.

### Manufacturing of the Foam Sandwich Panel:

The sandwich foam panel was prepared by the similar procedure as specified in example 1 by using the recyclable epoxy prepared as prepared in example 4. The curing in an oven was done at 60° C. for 3 hours.

Mechanical properties of the foam sandwich panel: The compressive tests were performed according to standard ISO 844 to evaluate the properties of the prepared sandwich The mechanical properties of the prepared foam sandwich panels are tabulated in table 10 below:

TABLE 10
Mechanical properties of the prepared foam sandwich panel

| S. No. | Properties | Example 4 | |
|---|---|---|---|
| 1. | Density | 170 | kg/cm³ |
| 2. | Compressive strength | 2.80 | MPa |
| 3. | Specific compressive | 19 | Nm/g |
| | strength | | |
| 4. | Tg after post cure at | 86° | C. |
| | 120° C. for 2 hours | | |

### Example 5: Preparation of a Low-Density Foam with Density <100 kg/m³ in Accordance with an Embodiment of the Present Disclosure

Preparation of the epoxy resin component: The epoxy resin component was prepared by mixing Epotec YD127, Epotec® RD 107, Disperbyk 2152, Wacker® Silres BS94, and 3M H38HS in the specified percentage as mentioned in Table 11 below in a vessel at 23° C. for 15 minutes. The epoxy resin component prepared was mixed until completely homogenized with the help of an electric stirrer with a stirring rate of 100-200 rpm.

TABLE 11
The Epoxy resin component

| S. | | Quantity |
|---|---|---|
| No | Component | (in w/w %) |
| 1. | Epotec ® YD 127 | 72.6 |
| 2. | Epotec ® RD 107 | 8.1 |
| 3. | Disperbyk 2152 | 2.0 |
| 4. | Silres BS94 | 2.0 |
| 5. | 3M H38HS | 15.3 |

To the 100 grams of the prepared epoxy resin component, 22 grams of RC (I) as added and mixed thoroughly to prepare the recyclable epoxy resin. The prepared recyclable epoxy resin was poured into a mould. The mould was placed in an oven at 80° C. for 2 hours for curing. The resulting foam formed showed a homogenous cell structure and a density of 96 kg/m³.

The prepared low-density foam can be used in sporting goods such as surfboards.

Mechanical properties of the foam sandwich panel: The compressive tests were performed according to standard ISO 844 to evaluate the properties of the prepared sandwich The mechanical properties of the prepared foam sandwich panels are tabulated in table 12 below:

TABLE 12
Mechanical properties of the prepared foam sandwich panel

| S. No. | Properties | Example 4 |
|---|---|---|
| 1. | Density | 96 kg/cm³ |

### Example 5: Preparation of One-Shot High Thickness Foam of Height >150 mm in Accordance with an Embodiment of the Present Disclosure

Preparation of the epoxy resin component: The epoxy resin component was prepared by mixing Epotec® YD 127, Wacker® Silres BS94, 3M H38HS and silica in the specified percentage as mentioned in Table 13 below in a vessel at Epotec® YD 127° C. for 15 minutes. The epoxy resin component prepared was mixed until completely homogenized with the help of an electric stirrer with a stirring rate of 100-200 rpm.

TABLE 13
The Epoxy resin component

| S. | | Quantity |
|---|---|---|
| No | Component | (in w/w %) |
| 1. | Epotec ® YD 127 | 81.6 |
| 2. | Wacker ® Silres BS94 | 2.0 |
| 3. | 3M H38HS | 15.3 |
| 4. | Silica | 1.0 |

To the 100 grams of the prepared epoxy resin component, 25 grams of RC (I) was added and mixed thoroughly to prepare the recyclable epoxy resin.

The prepared recyclable epoxy resin was poured into a cardboard mould with the dimensions 24.5 cm×31 cm×20 cm. The reaction of the epoxy resin component and RC (I) was carried out at room temperature for 5 hours. The exothermic reaction was observed during the curing of the epoxy resin component and the recyclable curing agent however, the temperature did not exceed a critical value. The resulting foam shows isolated coarse pores with an overall homogenous cell structure. The height of the resulting foam is between 160 mm and 200 mm.

Mechanical properties of the foam sandwich panel: The compressive tests were performed according to standard ISO 844 to evaluate the properties of the prepared sandwich The mechanical properties of the prepared foam sandwich panels are tabulated in table 14 below:

TABLE 14
Mechanical properties of the prepared foam sandwich panel

| S. No. | Properties | Example 4 | |
|---|---|---|---|
| 1. | Height | 160-200 | mm |
| 2. | Compressive | 1.70 | MPa |
| | strength | | |

TABLE 15
Mechanical properties of the prepared sandwich
foam panels of examples 2 and 3 were compared
with the commercially available foam materials.

| Mechanical | | | | | |
|---|---|---|---|---|---|
| properties | Example 2 | Example 3 | GR 150 | KG 150 | FR 150 |
| Density | 142 | 185 | 150 | 150 | 150 |
| | kg/cm³ | kg/cm³ | kg/cm³ | kg/cm³ | kg/cm³ |
| Compressive | 2.62 | 3.79 | 2.60 | 2.49 | 2.30 |
| strength | MPa | MPa | MPa | MPa | MPa |
| Specific | 18.45 | 20.49 | 17.33 | 16.60 | 15.33 |
| compressive | Nm/g | Nm/g | Nm/g | Nm/g | Nm/g |
| strength | | | | | |

* GR 150: Armacell ® Core GR (PET Foam);
* FR 150: Armacell ® Core FR (PET Foam, fire retardant);
* KG 150: Gurit ® Kerdyn ® Green (PET Foam).

Observations: The conducted test showed comparable compressive properties to commercial foam material proving the competitiveness of this new approach for recyclable foams.

### Example 6: Recycling of the Composite Structure in Accordance with an Embodiment of the Present Disclosure

Specimens (10 μm) of a cubic foam sandwich panel laminated on top and bottom side with glass fabric Saertex X-E-610 g/m², having a thickness of 37 mm and a surface area of 55×55 mm² was immersed into 25 wt. % acetic acid at 80° C. in a foil sealed beaker. The solution was heated on a hot plate at 80° C. with continuous stirring. Within 30 minutes, the specimen started to soften and disintegrating in the acid solution. The top and bottom glass fibre of the sandwich panel, the reinforcing component and the filler were recovered from the solution. Within approximately 4 hours, the specimen completely dissolved in the acid solution resulting in the formation of solved matrix material.

TABLE 16
Time taken for the dissolution of the cubic foam sandwich panel

| | | |
|---|---|---|
| | | Percentage |
| Time | Weight | weight |

| | | | |
|---|---|---|---|
| Start, t₀ | 28.06 | g | 100% |
| t₁ = 1 hour | 19.52 | g | 69.6% |
| t₂ = 2 hours | 8.71 | g | 31.0% |
| t₃ = 3 hours | 4.16 | g | 14.8% |
| t₄ = 4 hours | 0.10 | g | 0.4% |
| t₅ = 4.2 hours | 0.00 | g | 0% |

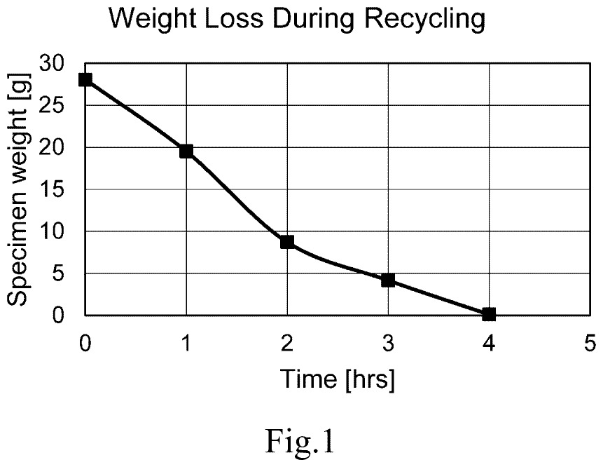

FIG. 1 depicts the weight loss of the cubic foam sandwich panel during recycling in an acetic acid solution.

Post dissolution of the specimen, mild sodium hydroxide was added in the solution containing the solved matrix material resulting in precipitation of thermoplastic particles. The obtained thermoplastic particles were filtered and rinsed with water, followed by drying in an oven at 70° C.

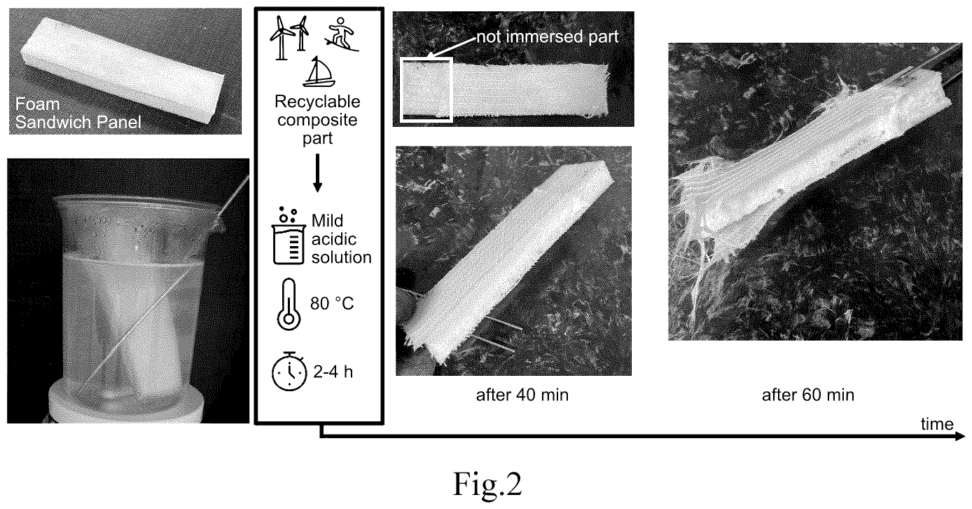

FIG. 2 depicts the recovery process of the recyclable epoxy resin in the form of thermoplastic particles.

TABLE 17
Amount of the obtained thermoplastic material post dissolution

| | Weight of thermoplastic |
|---|---|
| Time of Measurement | material |
| After rinsing in water, t₀ | 47.0 g (wet particles) |
| After drying at 70° C./14 hrs | 14.1 g (dry particles) |
| After additional drying at | 14.1 g (dry particles) |
| 100° C./3 hrs | |

TABLE 18
The theoretical initial weight of recyclable epoxy resin

| Component | Weight | |
|---|---|---|
| Total weight specimen | 28.06 | g |
| Glass fabrics | 3.70 | g |
| Inorganic fillers in foam resin | 3.38 | g |
| Recyclable infusion resin (50/50 | 1.85 | g (included) |
| resin/fabric ratio) | | |
| Initial recyclable epoxy matrix | 20.98 | g |

$$Recycling Yield = \frac{\text{?}}{\text{?}} * 100 = \frac{mass of dry particles}{mass of initial recyclable epoxy} * 100$$

$$\text{?} \text{indicates text missing or illegible when filed}$$

After washing and drying the glass fabrics, they are used again for other applications. In total, 67% of the initial recyclable epoxy resin material was recovered and 13% of the initial test specimen i.e., the glass fabrics, can be reused in new applications.

### Properties of the Obtained Thermoplastic Material

The recovered thermoplastic material was characterized by Differential scanning calorimetry, which showed a glass transition temperature at 78° C. and a melting point at 313° C., what makes it comparable to polyamide 66. The thermoplastic material was further micronized and used as a toughener additive in recyclable foam or in other plastic-processing industries. The obtained thermoplastic material can also be used as a primer in adhesives industry.

The recovered glass fabrics or the carbon fibre was further processed to short fibres and used as the reinforcing fibre in recyclable epoxy composite structures. Also, other reinforcing component such as inorganic fillers was filtered, followed by washing. The reinforcing component can be reused again in the formation of the composite structure.

### INDUSTRIAL APPLICATION

The composite structure in accordance with the present disclosure possesses desirable processing and performance properties suitable for wide ranging composite processes. The composite structure of the present disclosure is also suitable for applications in high-tech fields for examples aircraft, spacecraft structures, aerospace, microelectronics, transportation, sporting goods such as surf boards.

The composite structure has suitable characteristic that make them amenable for use in standard thermosetting composite manufacturing techniques such as wet lay-up, filament winding, vacuum infusion, compression molding, resin transfer molding. These composites materials have excellent mechanical properties that make them useful for different composite applications. These composite materials can also be degraded under specific conditions, leading to the separation and recovery of the reinforcing fibre, the reinforcing component, the filler, and obtaining the thermoplastic material. These composite materials can be recycled precisely because the skin sheet and the core member of the composite structure is derived from the recyclable curing agent. The recycling of degradable composite structure helps in the recovering the reinforcement material and other valuable components of the composite structure with high efficiency.

We claim:

1. A composite structure comprising two skin sheets, and a core member arranged between the two skin sheets, wherein,
the skin sheet comprises a reinforcing fibre impregnated with a recyclable epoxy resin; and
the core member comprises the recyclable epoxy resin, a reinforcing component, and a foaming agent,
the recyclable epoxy resin comprising at least one epoxy resin component and a recyclable curing agent wherein the recyclable curing agent is selected from a group consisting of a compound of Formula (I): 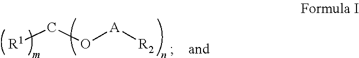
wherein:
if m is 2, then n is 2;
if m is 1, then n is 3; or
if m is 0, then n is 4;
each R¹ is independently hydrogen, alkyl, cycloalkyl, heterocycle, heterocycloalkyl, alkenyl, cycloalkenyl, aryl, heteroaryl, alkoxyalkyl, or alkynyl;
each A is independently alkyl, alkylene, alkenene, alkylene-hetero-alkylene, alkylene-heterocyclo-alkylene, carbonyl, thiocarbonyl, alkylene-oxy-alkylene, 1,4-alkyl substituted piperazine, aryl, or heteroaryl;
each R² is independently —NHR₃, —SH, or heterocycloalkyl, wherein each R³ is independently hydrogen, alkyl, aminoalkyl, alkylaminoalkyl, cycloalkyl, heterocycle, alkenyl, aryl, or heteroaryl; or, every two —O-A-R2 groups, together with the carbon atom to which they are attached to, can independently form an dioxanyl ring with no less than 4 ring members and one or more of the ring carbon atom(s), other than the carbon atom to which the two —O-A-R2 groups are attached, are independently substituted with one or more independent amino group or aminoalkyl wherein each amino is independently a primary or secondary amino group; and
a compound of Formula (II): 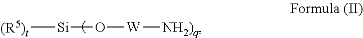
wherein:
q is 4, 3, 2, or 1;
tis 0, 1, 2, or 3;
the sum of q and t is 4;
each occurrence of W is independently alkylene, cycloalkylene, heterocyclylene, alkenylene, alkynylene, cycloalkenylene, arylene, or heteroarylene; and
each occurrence of R⁵ is independently hydrogen, alkyl, aminoalkyl, cycloalkyl, heterocyclyl, alkenyl, alkynyl, cycloalkenyl, aryl, heteroaryl or —OR^{c}, wherein R^{c} is alkyl, cycloalkyl, heterocyclyl, alkenyl, alkynyl, cycloalkenyl, aryl or heteroaryl.

2. The composite structure of claim 1, wherein in the compound of Formula (I) m is 2, n is 2; each R¹ is independently hydrogen or alkyl; each A is independently alkyl, or aryl; each R² is independently —NHR³, or —SH; and each R³ is independently hydrogen or alkyl.

3. The composite structure of claim 1, wherein in the compound of Formula (II) q is 3 or 4; tis 1 or 0; W is independently alkylene, cycloalkylene, or arylene; and each occurrence of R5 is independently hydrogen, alkyl, or aminoalkyl.

4. The composite structure of claim 1, wherein the compound of Formula (I) is a compound of Formula (III) represented by: 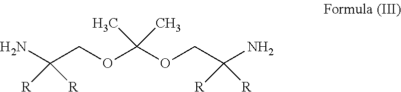
wherein each R is independently hydrogen, methyl or ethyl.

5. The composite structure of claim 1, wherein the compound of Formula (II) is a compound of Formula (IV) represented by: 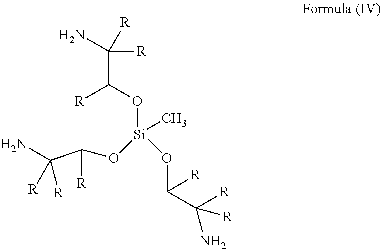
wherein each R is independently hydrogen, methyl or ethyl.

6. The composite structure as claimed in claim 1, wherein the epoxy resin component is selected from a group consisting of diglycidyl ether of bisphenol A, diglycidyl ether of bisphenol F, a mixture of diglycidyl ether of bisphenol A and bisphenol F, a cycloaliphatic epoxy resin and a combination thereof.

7. The composite structure as claimed in claim 1, wherein the reinforcing fibre is selected from a group consisting of a glass fibre, a carbon fibre, a ceramic fibre, a natural fibre and a combination thereof.

8. The composite structure as claimed in claim 1, wherein the reinforcing component is selected from a group consisting of hollow glass sphere, chopped glass fibres, chopped carbon fibres, natural fibres, expanded glass, polymer spheres and a combination thereof.

9. The composite structure as claimed in claim 1, wherein the foaming agent is selected from the group consisting of an anhydrous silicone and functional carbonic acid diamides.

10. The composite structure as claimed in claim 1, wherein the core member further comprises a flexibilization agent, a filler, a dispersing agent, optionally a reactive diluent and a solid toughener.

11. The composite structure as claimed in claim 1, wherein the stochiometric ratio of the epoxy resin component and the recyclable curing agent is in the range between 100:20 to 100:30.

12. The composite structure as claimed in claim 1, wherein the composite structure has a thickness of from 10 millimeters to 40 millimeters.

13. The composite structure as claimed in claim 1, wherein the compressive strength of the composite structure having a thickness of between 10 millimeters to 40 millimeters is in a range of 5.0 MPa to 1.2 MPa.

14. The composite structure as claimed in claim 1, wherein the density of the composite structure having a thickness of between 10 millimeters to 40 millimeters is in a range of 450 kg/m³ to 220 kg/m³.

15. The composite structure as claimed in claim 1, wherein the composite structure has a glass transition temperature of between 75° C. to 110° C. when the composite structure is post-cured at 120° C. for 2 hours.

16. The composite structure as claimed in claim 1, wherein the composite structure is capable of disintegrating when immersed in an acid solution at a temperature in a range of 80° C. to 110° C., to recover the reinforcing fibre, the reinforcing component, and the filler; and obtaining a thermoplastic material.

17. An epoxy resin for preparing a recyclable epoxy foam, the epoxy resin comprising at least one epoxy resin component, a recyclable curing agent, a reinforcing component, and a foaming agent wherein the recyclable curing agent is selected from a group consisting of a compound of Formula (I) and Formula (II):
wherein the compound of Formula (I) is a compound of Formula (III) represented by: 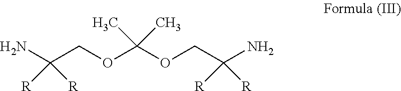
wherein each R is independently hydrogen, methyl or ethyl; and
wherein the compound of Formula (II) is the compound of Formula (IV) represented by: 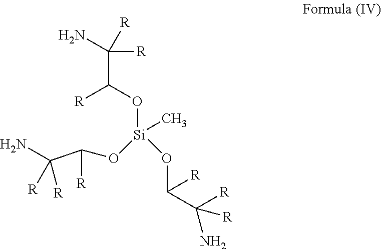
wherein each R is independently hydrogen, methyl or ethyl.

18. The epoxy resin for preparing the recyclable epoxy foam, as claimed in claim 17, wherein the recyclable epoxy foam has a density of not more than 100 kg/m³, the epoxy resin comprising:
a reaction product of hexane-1,6-diol with 2-(chloromethyl) oxirane;
hyperbranched polyester added in a range of 1.5-2.0% phr;
polymethylhydrogensiloxane added in a range of 2.0-3.0% phr;
glass hollow bubbles added in a range of 13.0-16.0% phr; and
the compound of Formula (I), wherein the compound of formula (I) is: 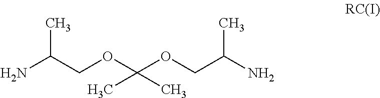
wherein the epoxy resin is cured at a temperature in a range between 70-90° C.

19. The epoxy resin for preparing the recyclable epoxy form, as claimed in claim 17, wherein the epoxy foam has a thickness in a range of 160 mm to 200 mm, the epoxy resin comprising:
reactive diluted BPA-resin with a viscosity in a range of 1,000-1,500 mPa·s;
fumed silica added in a range of 0.5-1.5% phr;
polymethylhydrogensiloxane added in a range of 2.0-3.0% phr;
glass hollow bubbles added in a range of 13.0-16.0% phr; and
the compound of Formula (I), wherein the compound of formula (I) is: 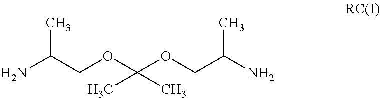
wherein the epoxy resin is cured at a temperature between 20-30° C.
